(19) United States
(12) Patent Application Publication
(10) Pub. No.: US 2014/0170448 A1
(43) Pub. Date: Jun. 19, 2014

(54) LITHIUM-ION SECONDARY BATTERY

(71) Applicants: Norio Iwayasu, Tokyo (JP); Hidetoshi Honbou, Tokyo (JP)

(72) Inventors: Norio Iwayasu, Tokyo (JP); Hidetoshi Honbou, Tokyo (JP)

(21) Appl. No.: 14/125,822

(22) PCT Filed: Jun. 13, 2011
(86) PCT No.: PCT/JP2011/003325

§ 371 Date: Dec. 12, 2013

(51) Int. Cl. H01M 10/42

(52) U.S. Cl. CPC H01M 10/4235
USPC 429/61

(57) ABSTRACT

A lithium-ion secondary battery having a positive electrode capable of occluding and releasing lithium ions, a negative electrode capable of occluding and releasing lithium ions, a separator interposed between the positive electrode and the negative electrode, an electrolytic solution, and a current breaking mechanism that works in response to the rise of the battery's internal pressure, wherein the electrolytic solution is incorporated with an aromatic compound and the positive electrode is incorporated with a carbon dioxide gas generating agent which is represented by the formula AxCO3 or AyHCO3. It is highly responsive to overcharging owing to the current breaking mechanism attached thereto which activates in the early stage of overcharging. Therefore, it exhibits high battery performance as well as high safety in the case of overcharging.

### TECHNICAL FIELD

The present invention relates to a lithium-ion secondary battery.

### BACKGROUND ART

Lithium-ion secondary batteries find general use in the field of notebook computers and portable telephones owing to the high energy density which characterizes them. In recent years, they are expected to find use as the power source for electric vehicles attracting attention from the standpoint of preventing global warming due to increasing carbon dioxide gas exhausted from automobiles.

Despite their outstanding characteristic properties, lithium-ion secondary batteries still have some problems to be addressed. One of them is improvement in safety. Particularly, it is important to ensure their safety when they undergo overcharging.

When overcharged, lithium-ion secondary batteries decrease in thermal stability, which deteriorates the safety. For this reason, various technologies are being developed to protect lithium-ion secondary batteries from overcharging.

Patent Documents 1 and 2 disclose a technology for adding an aromatic compound to lithium-ion secondary batteries to improve their stability in the case of overcharging.

Patent Documents 3 and 4 disclose a technology for incorporating lithium carbonate into the positive electrode to ensure safety in the case of overcharging in lithium-ion secondary batteries provided with a current breaking valve that works as the internal pressure increases. According to this technology, the lithium carbonate undergoes electrochemical decomposition in the positive electrode which is at a high potential, thereby generating carbon dioxide gas, which increases the battery's internal pressure and activates the current breaking valve. This is the mechanism to ensure the battery's safety in the case of overcharging.

### PRIOR ART REFERENCES

### Patent Documents

Patent Document 1: JP-2004-349131-A
Patent Document 2: JP-2003-297425-A
Patent Document 3: JP-2008-277106-A
Patent Document 4: JP-2008-186792-A
Patent Document 5: JP-1998-270003-A
Patent Document 6: JP-1998-92409-A

### SUMMARY OF THE INVENTION

### Problems to be Solved by the Invention

The simple addition of an aromatic compound to the battery as disclosed in Patent Documents 1 and 2, however, is not sufficient to ensure safety in the case of overcharging.

The incorporation with lithium carbonate as disclosed in Patent Documents 3 and 4 also involves the difficulty that the battery would undergo thermal runaway before lithium carbonate starts reaction in some cases because lithium carbonate has a high reaction potential of 4.8-5.0 V vs. Li/Li⁺ and starts reaction only in the terminal stage of overcharging. Another problem is that lithium carbonate is poor in stability at a high potential. In other words, lithium carbonate as the gas generating agent poses various problems as mentioned above when it is used alone.

For the battery to have high safety in the case of overcharging, it is necessary that the current breaking valve should work in the early stage of overcharging. It is also necessary to establish a technology for suppressing overcharging without affecting the battery performance.

### Means for Solving the Problem

The present invention covers a lithium-ion secondary battery including a positive electrode capable of occluding and releasing lithium ions, a negative electrode capable of occluding and releasing lithium ions, a separator interposed between the positive electrode and the negative electrode, an electrolytic solution, and a current breaking mechanism that works as the battery's internal pressure increases. The lithium-ion secondary battery is characterized in that the electrolytic solution contains an aromatic compound and the positive electrode contains an agent to generate carbon dioxide gas, which is represented by the general formula of AₓCO₃ or A_{y}HCO₃ (where A denotes an alkali metal with the atomic number of 11 and above or alkaline earth metal with the atomic number of 4 and above; x is 2 if A is an alkali metal or 1 if A is an alkaline earth metal; and y is 1 if A is an alkali metal or 0.5 if A is an alkaline earth metal). It is also characterized in that the aromatic compound is one represented by Formula (1) or (2) below or benzene.

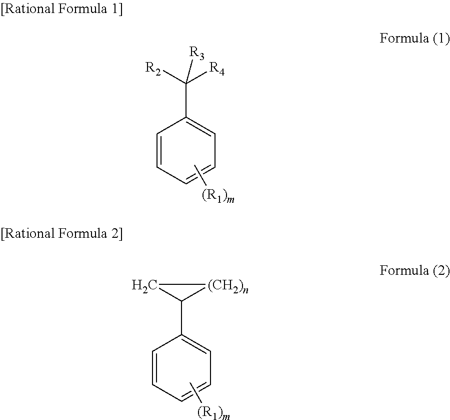

In Formula (1), R₁ denotes a hydrogen atom or hydrocarbon group, with m being no larger than 5 if R₁ denotes a hydrocarbon group, and each of R₂ to R₄ denotes a hydrogen atom or hydrocarbon group.

The aromatic compound represented by Formula (2) is one which has a substituent of alicyclic hydrocarbon. In Formula (2), R₁ denotes a hydrogen atom or hydrocarbon group, with m being no larger than 5 if R₁ denotes a hydrocarbon group, and n is 1 to 14.

### Effects of the Invention

The lithium-ion secondary battery according to the present invention permits the current breaking valve to work in the early stage of overcharging, which leads to improved safety. Moreover, it is incorporated with an inexpensive carbonate or hydrogenecarbonate which helps reduce its production cost. Other constitutions, effects, and problems not mentioned above will become clear from the embodiments mentioned hereunder.

### BRIEF DESCRIPTION OF THE DRAWINGS

FIG. 1 is an illustration for the evolution of gas at the time of overcharging.

FIG. 2 is a sectional view showing a battery of wound type.

### MODES FOR CARRYING OUT THE INVENTION

The embodiments of the present invention will be described in detail with reference to the accompanying drawings. They are intended to concretely illustrate, not to restrict, the scope of the present invention. They may be properly modified and changed by those who are skilled in the art within the technical idea disclosed herein. Incidentally, the accompanying drawings identify same parts with same reference numerals without repeated explanation.

One of the conventional disclosed technologies to ensure safety in the case of overcharging is designed to incorporate the battery with an aromatic compound which generates a gas in the case of overcharging, thereby actuating the current breaking valve. The disadvantage of this technology is that the aromatic compound generates hydrogen gas which is inherently incapable of activating the current breaking valve and is potentially dangerous.

Another conventional technology to prevent overcharging by employing lithium carbonate which evolves a gas has a disadvantage of being unable to quickly respond to overcharging because lithium carbonate has a high reaction potential of 4.8 to 5.0 V vs. Li/Li⁺ and starts reaction only in the terminal stage of overcharging.

Lithium carbonate is only one known substance that is applicable to the lithium-ion secondary battery and evolves carbon dioxide gas through electrochemical decomposition. Other carbonates and hydrogencarbonates, such as sodium carbonate and sodium hydrogencarbonate, hardly decompose electrochemically, and hence they do not ensure safety in the case of overcharging. In addition, lithium carbonate is more expensive than sodium carbonate and sodium hydrogencarbonate, and hence it is unfavorable to production cost. Moreover, lithium carbonate deteriorates the battery performance such as storage stability at high temperatures. Thus, the less the amount of lithium carbonate, the better the battery performance but the less the safety from overcharging.

The present invention employs an aromatic compound and a compound in combination which generate protons and carbon dioxide gas, respectively, through electrochemical reactions at a potential higher than a certain level, so that the current breaking valve is activated in the early stage of overcharging.

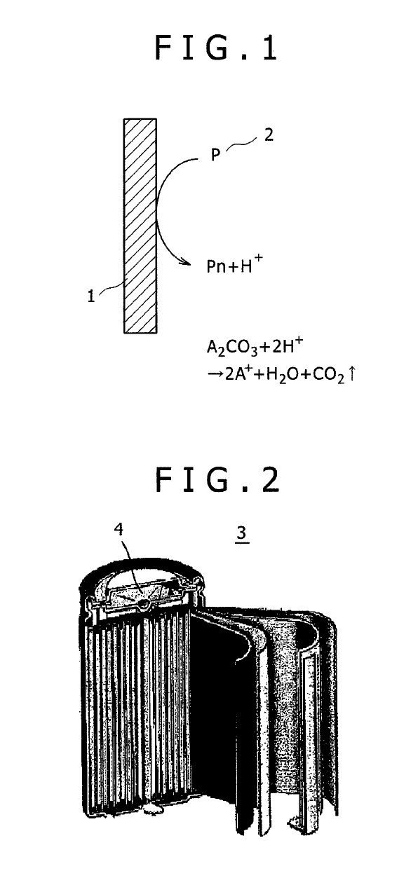

FIG. 1 shows the mechanism of gas evolution in the case of overcharging. The aromatic compound 2 generates protons in the vicinity of the positive electrode 1 as the battery increases in potential due to overcharging. The thus generated protons neutralize the carbon dioxide gas evolving compound, thereby evolving carbon dioxide gas. The thus generated carbon dioxide gas activates the current breaking valve, which in turn suspends charging.

The aromatic compound used in the present invention, which generates protons through electrochemical reactions at a potential higher than a certain level, is illustrated by those represented by the formulas (1) and (2) and also by benzene. The lithium-ion secondary battery usually has a working potential of 2.5-4.3 V. It is in an overcharged state when its working potential exceeds 4.5 V. In order to prevent overcharging, the battery should preferably be provided with a means to generate a gas when the battery voltage exceeds 4.5 V. It is desirable that the aromatic compound starts reactions at a potential of 4.4-4.8 V so that it quickly responds to overcharging, thereby generating protons. The upper value is a limit beyond which the aromatic compound does not respond quickly to overcharging. The lower value is a limit beyond which the aromatic compound starts reaction while the battery is working normally. This would lead to the deterioration of the battery.

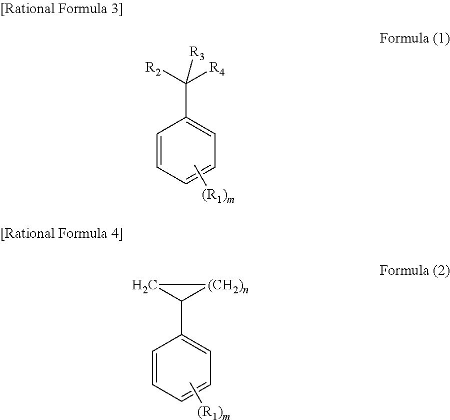

The above-mentioned working potential and overcharge voltage vary depending on the active material and design for the lithium-ion secondary battery. Consequently, it is desirable to adjust the reaction potential of the aromatic compound according to the working potential of the battery. The reaction potential of the aromatic compound can be adjusted by properly selecting its functional group. It is an advantage of the present invention that the potential for generation of carbon dioxide gas depends not only on the reaction potential of the carbon dioxide gas generating agent but also on the reaction potential of the aromatic compound having an adjustable reaction potential.

The aromatic compound represented by Formula (1) is one which has at least one substituent of alicyclic hydrocarbon. In Formula (1), R₁ denotes a hydrogen atom or hydrocarbon group. The hydrocarbon group is illustrated by aliphatic hydrocarbon groups (CₙH₂ₙ₊₁), alicyclic hydrocarbon groups (CₙH₂ₙ₋₁), and aromatic hydrocarbon groups. Examples of the aliphatic hydrocarbon group include methyl group, ethyl group, propyl group, isopropyl group, butyl group, isobutyl group, dimethylethyl group, pentyl group, hexyl group, heptyl group, octyl group, isooctyl group, decyl group, undecyl group, and dodecyl group. Examples of the alicyclic hydrocarbon group include cyclopropyl group, cyclobutyl group, cyclopentyl group, cyclohexyl group, cycloheptyl group, cyclooctyl group, cyclononyl group, and cyclodecyl group. The aromatic group is a functional group having no more than 20 carbon atoms that satisfies the Hückel's rule. n denotes a numeral no smaller than 1 and no larger than 14. If R₁ is a hydrocarbon group, m denotes a numeral no larger than 5.

In Formula (2), each of R₁ to R₄ denotes a hydrogen atom or hydrocarbon group. The hydrocarbon group is illustrated by aliphatic hydrocarbon groups (CₙH₂ₙ₊₁), alicyclic hydrocarbon groups (CₙH₂ₙ₋₁), and aromatic hydrocarbon groups. Examples of the aliphatic hydrocarbon group include methyl group, ethyl group, propyl group, isopropyl group, butyl group, isobutyl group, dimethylethyl group, pentyl group, hexyl group, heptyl group, octyl group, isooctyl group, decyl group, undecyl group, and dodecyl group. Examples of the alicyclic hydrocarbon group include cyclopropyl group, cyclobutyl group, cyclopentyl group, cyclohexyl group, cycloheptyl group, cyclooctyl group, cyclononyl group, and cyclodecyl group. The aromatic group is a functional group having no more than 20 carbon atoms that satisfies the Hückel's rule. If R₁ is a hydrocarbon group, m denotes a numeral no larger than

According to the present invention, the compound represented by Formula (1) or Formula (2) or benzene is added to the electrolytic solution in such an amount that its concentration is more than 0 wt % and less than 50 wt %, preferably no lower than 0.01% and no higher than 10 wt %. An adequate amount of addition ensures the battery's good performance as well as the battery's high safety in the case of overcharging as intended by the present invention. They may be used alone or in combination with one another.

The compound that generates carbon dioxide gas neutralizes protons generated by the aromatic compound, thereby generating carbon dioxide gas. Therefore, the compound that generates carbon dioxide gas includes not only lithium carbonate (which generates carbon dioxide gas in response to the varying potential) but also any compound that generate carbon dioxide gas through neutralization with protons.

According to the present invention, the compound that generates carbon dioxide gas through neutralization (the compound being referred to as a carbon dioxide gas generating agent) is a carbonate or a hydrogencarbonate which is represented by the formula AₓCO₃ or A_{y}CHO₃ (where A denotes an alkali metal with the atomic number 11 and above or an alkaline earth metal with the atomic number 4 and above, and x is 2 if A denotes an alkali metal or 1 if A denotes an alkaline earth metal, and y is 1 if A denotes an alkali metal or 0.5 if A denotes an alkaline earth metal). Typical examples of the compound include sodium carbonate, potassium carbonate, rubidium carbonate, cesium carbonate, beryllium carbonate, magnesium carbonate, calcium carbonate, strontium carbonate, barium carbonate, lithium hydrogen carbonate, sodium hydrogen carbonate, potassium hydrogen carbonate, rubidium hydrogen carbonate, cesium hydrogen carbonate, beryllium hydrogen carbonate, magnesium hydrogen carbonate, calcium hydrogen carbonate, strontium hydrogen carbonate, and barium hydrogen carbonate. Preferable among them from the standpoint of battery performance and battery safety are sodium carbonate, potassium carbonate, magnesium carbonate, calcium carbonate, strontium carbonate, barium carbonate, lithium hydrogen carbonate, sodium hydrogen carbonate, potassium hydrogen carbonate, magnesium hydrogen carbonate, calcium hydrogen carbonate, strontium hydrogen carbonate, and barium hydrogen carbonate. The carbon dioxide gas generating agents mentioned above may be used alone or in combination with one another. The carbon dioxide gas generating agents mentioned above may also be used with lithium carbonate. They may be used in combination with lithium carbonate in an amount of 10 to 80 wt %. An amount less than 10 wt % is too small to produce the effect of suppressing overcharging. An amount more than 80 wt % is detrimental to storage stability at high temperatures.

The carbon dioxide gas generating agent should preferably be one which remains stable regardless of potential. (It is not restricted to one which evolves carbon dioxide gas according as the potential increases.) Lithium carbonate or the like, which is sensitive to potential, is capable of reaction that proceeds in response to the battery's potential. This may lead to the deterioration of the battery. Examples of the carbon dioxide gas generating agent which is stable regardless of potential include sodium carbonate, potassium carbonate, magnesium carbonate, calcium carbonate, sodium hydrogen carbonate, potassium hydrogen carbonate, magnesium hydrogen carbonate, and calcium hydrogen carbonate.

Preferable pricewise among the carbon dioxide gas generating agents mentioned above are sodium carbonate, potassium carbonate, magnesium carbonate, calcium carbonate, and sodium hydrogen carbonate.

According to the present invention, the carbon dioxide gas generating agent should exist in the positive electrode. This construction may be achieved by knife-coating an aluminum foil or the like, which functions as the positive electrode, with a slurry mixture containing a carbon dioxide gas generating agent, an active material, a conducting agent, a binder, and other additives. Alternatively, a carbon dioxide gas generating agent in the form of fine particles may be sprayed onto the previously prepared positive electrode, or a carbon dioxide gas generating agent may be applied to the positive electrode which already contains a carbon dioxide gas generating agent.

The carbon dioxide gas generating agent should be added in an amount (X) of 0<X<50 wt %, preferably 0<X<5 wt %, for the weight of the positive electrode including active material, conducting agent, and binder. The amount (X) specified above is essential for the lithium-ion secondary battery to produce its outstanding battery performance as well as the effect of the present invention.

According to the present invention, it is permissible to use the above-mentioned carbonate and/or hydrogencarbonate (E) and lithium carbonate (F) in combination with each other. In this case, their mixing ratio should be such that 0<F/(E+F)<1. Their combined use prevents the battery from deterioration in storage stability at high temperatures that occurs when lithium carbonate is used alone.

The lithium-ion secondary battery according to the present invention has a positive electrode made of an oxide represented by the formula LiMO₂ (where M denotes a transition metal), which is capable of occluding and releasing lithium ions. The oxide may be that of lamellar structure which is illustrated by LiCoO₂, LiNiO₂, LiMn_{1/3}Ni_{1/3}Co_{1/3}O₂, and LiMn_{0.4}Ni_{0.4}Co_{0.2}O₂, in which M may be replaced by at least one metal element selected from the group consisting of Al, Mg, Mn, Fe, Co, Cu, Zn, Ti, Ge, W, and Zr. The oxide may also be that of spinel structure which is illustrated by LiMn₂O₄ and Li₁₊ₓMn₂₋ₓO₄. Moreover, the oxide may be that of olivine structure illustrated by LiFePO₄ and LiMnPO₄.

The lithium-ion secondary battery according to the present invention has a negative electrode made of natural or artificial graphite or any other carbonaceous material. The artificial graphite is one which is obtained from petroleum coke or coal pitch coke by graphitization at 2500° C. and above. The carbonaceous material includes mesophase carbon, amorphous carbon, and carbon fiber. The negative electrode may also be made of any metal alloyable with lithium or carbon particles carrying metal on their surface. Examples of such metal include lithium, silver, aluminum, tin, silicon, indium, gallium, and magnesium, and alloys thereof. The negative electrode may also be made of any one of the metals or oxides thereof. An additional material for the negative electrode is lithium titanate.

According to the present invention, the lithium-ion secondary battery has an electrolytic solution containing an aromatic compound capable of generating protons. This electrolytic solution is composed a nonaqueous solvent and a supporting electrolyte dissolved therein. The nonaqueous solvent is not specifically restricted so long as it is capable of dissolving the supporting electrolyte. It should preferably be an organic solvent such as diethyl carbonate, dimethyl carbonate, ethylene carbonate, ethyl methyl carbonate, propylene carbonate, γ-butyrolactone, tetrahydrofuran, and dimethoxyethane. They may be used alone or in combination with one another. The organic solvent may be mixed with vinylene carbonate or vinyl ethylene carbonate which has an unsaturated double bond in the molecule.

The supporting electrolyte used in the present invention is not specifically restricted so long as it is soluble in the nonaqueous solvent. Its preferred examples include electrolyte salts as follows: LiPF₆, LiN(CF₃SO₂)₂, LiN(C₂F₆SO₂)₂, LiClO₄, LiBF₄, LiAsF₆, LiI, LiBr, LiSCN, Li₂B₁₀Cl₁₀, and LiCF₃CO₂. They may be used alone or in combination with one another.

The lithium-ion secondary battery according to the present invention has a current breaking mechanism, which may be an ordinary gas releasing valve that opens at a prescribed internal pressure, as disclosed in Patent Documents 5 and 6. This gas releasing valve opens before the battery bursts when the internal pressure of the battery abruptly rises due to thermal runaway, so that gas is released from the battery can. Thus, the lithium-ion battery provided with such a gas releasing valve will not burst and scatter about its content from its container even though its internal pressure rises. Incidentally, the gas releasing valve is so constructed as to deform and open, thereby breaking the electric circuit.

FIG. 2 is a schematic diagram showing the lithium-ion secondary battery 6 provided with the ordinary current breaking valve 7.

### EXAMPLES

The invention will be described in more detail with reference to the following Examples which are not intended to restrict the scope thereof. The results obtained in Examples are summarized in Table 1.

### <Method for Producing Electrodes>

### <Positive Electrode>

A mixture was made from lithium cobaltate, conductive carbon, and polyvinylidene fluoride in a ratio of 95:2.5:2.5 by wt %. The resulting mixture was dispersed into N-methyl-2-pyrrolidone to give a slurry, which was subsequently incorporated with a carbon dioxide gas generating agent. The resulting slurry was finally applied onto an aluminum foil (20 μm thick) by knife coating, followed by drying.

### <Negative Electrode>

A mixture was made from artificial graphite and polyvinylidene fluoride in a ratio of 95:5 by wt %. The resulting mixture was dispersed into N-methyl-2-pyrrolidone to give a slurry. The resulting slurry was applied onto a copper foil (20 μm thick) by using a doctor blade, followed by drying.

### <Method for Producing Battery of 18650 Type and Evaluation of Battery Performance>

A battery sample for evaluation was prepared as follows. First, the positive electrode, the separator, and the negative electrode were wound all together to give a wound body. Next, the wound body was placed in a battery can for 18650 type. Finally, the battery can was filled with an electrolytic solution and sealed. Incidentally, the battery can has a current breaking mechanism at its upper part that works as the internal pressure rises. The thus obtained battery underwent three cycles of charging and discharging at a current value of 200 mA, with the voltage kept within the range of 3.0 V to 4.2 V. The current value measured in the third cycle of discharging was regarded as the battery capacity.

For the purpose of evaluating the battery characteristics during storage at high temperatures, the battery prepared as mentioned above was charged up to 4.2 V and then stored for 10 days in a thermostatic bath at 60° C. Then, the battery was cooled to room temperature and discharged once down to 3.0 V. Finally, the battery underwent charging and discharging repeatedly in the same way as mentioned above, and the discharging capacity was measured. The thus measured value was regarded as the battery capacity after storage.

### <Method for Overcharge Test>

A battery sample, which was prepared separately for evaluation of battery performance under overcharging, was tested as follows. It was charged up to 4.2 V and then overcharged up to 5.0 V with a current value of 2000 mA. After the battery voltage had reached 5.0 V, charging was continued at a constant potential of 5.0 V until the current value reached 50 mA. As the result of the overcharge test, the battery sample was rated as good if it neither bursts nor ignites and as poor if it bursts and/or ignites.

### (Example 1

An electrolytic solution was prepared from an electrolyte salt (LiPF₆) and a solvent (EC/DMC/EMC=1:1:1 by volume), with the amount of the former being 1 mol/L. To this electrolytic solution was added the aromatic compound A represented by the formula 1, where R₁=H, R₂=Me, R₃=Me, and R₄=H. The amount of the aromatic compound is 2.0 wt %. The positive electrode was incorporated with Na₂CO₃ (in an amount of 3 wt %) as a carbon dioxide gas generating agent. The results of evaluation indicated that the battery capacity is 2010 mAh and the battery capacity after storage at high temperatures is 1890 mAh. It was found that the current breaking valve worked at 4.6 V during the overcharging test. The battery sample tested for overcharging was rated as good without bursting and ignition.

### Example 2

The same procedure as in Example 1 was repeated except that the aromatic compound A was replaced by the aromatic compound B represented by the formula 1, where R₁=H, R₂=Me, R₃=Et, and R₄=H. The results of evaluation indicated that the battery capacity was 2010 mAh and the battery capacity after storage at high temperatures was 1900 mAh. It was found that the current breaking valve worked at 4.6 V during the overcharging test. The battery sample tested for overcharging was rated as good without bursting and ignition.

### Example 3

The same procedure as in Example 1 was repeated except that the aromatic compound A was replaced by the aromatic compound C represented by the formula 2, where R₁=H, n=4. The results of evaluation indicated that the battery capacity was 2010 mAh and the battery capacity after storage at high temperatures was 1885 mAh. It was found that the current breaking valve worked at 4.6 V during the overcharging test. The battery sample tested for overcharging was rated as good without bursting and ignition.

### Example 4

The same procedure as in Example 2 was repeated except that Na₂CO₃ was replaced by NaHCO₃. The results of evaluation indicated that the battery capacity was 2009 mAh and the battery capacity after storage at high temperatures was 1891 mAh. It was found that the current breaking valve worked at 4.6 V during the overcharging test. The battery sample tested for overcharging was rated as good without bursting and ignition.

### Example 5

The same procedure as in Example 2 was repeated except that a mixture of Na₂CO₃ and Li₂CO₃ was used as the carbon dioxide gas generating agent, with the ratio of the former (E) to the latter (F) being such that F/(E+F)=0.8. The results of evaluation indicated that the battery capacity is 2008 mAh and the battery capacity after storage at high temperatures is 1885 mAh. It was found that the current breaking valve worked at 4.6 V during the overcharging test. The battery sample tested for overcharging was rated as good without bursting and ignition.

### Example 6

The same procedure as in Example 5 was repeated except that the ratio of Na₂CO₃ to Li₂CO₃ was changed such that F/(E+F)=0.1. The results of evaluation indicated that the battery capacity is 2010 mAh and the battery capacity after storage at high temperatures is 1890 mAh. It was found that the current breaking valve worked at 4.6 V during the overcharging test. The battery sample tested for overcharging was rated as good, without bursting and ignition.

### Comparative Example 1

A battery sample was prepared which does not contain the aromatic compound and the carbon dioxide gas generating agent. The battery sample was found to have a battery capacity of 2010 mAh and also a battery capacity of 1901 mAh after storage at high temperatures. During the overcharge testing, the battery sample suffered bursting and ignition and hence it was rated as poor.

### Comparative Example 2

A battery sample was prepared in the same way as in Example 3 except that it does not contain the carbon dioxide gas generating agent. The battery sample was found to have a battery capacity of 2010 mAh and also a battery capacity of 1900 mAh after storage at high temperatures. During the overcharge testing, the battery sample suffered bursting and ignition and hence it was rated as poor.

### Comparative Example 3

A battery sample was prepared in the same way as in Comparative Example 2 except that the content of the aromatic compound was changed to 3 wt %. The battery sample was found to have a battery capacity of 2001 mAh and also a battery capacity of 1850 mAh after storage at high temperatures. During the overcharge testing, the battery sample suffered bursting although it did not suffer ignition and hence it was rated as poor.

### Comparative Example 4

A battery sample was prepared in the same way as in Example 1 except that the aromatic compound was not added and Li₂CO₃ was used as the carbon dioxide gas generating agent. The battery sample was found to have a battery capacity of 1995 mAh and also a battery capacity of 1860 mAh after storage at high temperatures. During the overcharge testing, the battery sample suffered bursting although it did not suffer ignition and hence it was rated as poor.

### Comparative Example 5

A battery sample was prepared in the same way as in Comparative Example 4 except that the amount of Li₂CO₃ was changed to 1.0 wt %. The battery sample was found to have a battery capacity of 2001 mAh and also a battery capacity of 1865 mAh after storage at high temperatures. During the overcharge testing, the battery sample suffered bursting although it did not suffer ignition and hence it was rated as poor.

Comparative Examples 2 and 3 demonstrate the batteries having no carbon dioxide gas generating agent. The batteries tested failed to activate the current breaking valve. A probable reason for this is that the batteries in Comparative Examples 2 and 3 are designed such that the current breaking valve is activated by hydrogen gas generated from the aromatic compound and hydrogen is inherently incapable of activating the current breaking valve.

Comparative Examples 4 and 5 demonstrate the batteries having no aromatic compound. The batteries tested activated the current breaking valve only at a high potential of 5.0 V and 5.1 V, respectively.

Examples 1 to 6 demonstrate the batteries incorporated with both the aromatic compound and the gas generating agent. The batteries tested successfully activated the current breaking valve at a potential of 4.6 V. The batteries in Examples 1 to 6 are more quickly responsive to overcharging than those in Comparative Examples 4 and 5 as evidenced by the fact that the former activate the current breaking valve at a lower potential than the latter.

The result of Example 2 is best among those of Examples 1 to 6. The battery in Example 2 is excellent in responsiveness to overcharging and storage stability at high temperatures. It is only slightly inferior in decline of battery performance to the one in Example 5 or 6 probably because it is incorporated with Na₂CO₃ which is stabler than LiCO₃. It is likely that LiCO₃ is poor in the effect of preventing overcharging if its amount is small and is also poor in storage stability at high temperatures if its amount is large.

TABLE 1

| | Aromatic compound | | | Gas generating agent | |
|---|---|---|---|---|---|
| | | | Amount | | Amount* |
| | Name | Structure | (wt %) | Formula | (wt %) |
| Example | | | | | |
| 1 | Aromatic | Formula (1) | 2.0 | Na₂CO₃ | 3.0 |
| | compound A | R₁ = H, R_{2,3} = Me, R₄ = H | | | |
| 2 | Aromatic | Formula (1) | 2.0 | Na₂CO₃ | 3.0 |
| | compound B | R₁ = H, R₂ = Me, R₃ = Et, R₄ = H | | | |
| 3 | Aromatic | Formula (2) | 2.0 | Na₂CO₃ | 3.0 |
| | compound C | R₁ = H, n = 4 | | | |
| 4 | Aromatic | Formula (1) | 2.0 | NaHCO₃ | 3.0 |
| | compound B | R₁ = H, R₂ = Me, R₃ = Et, R₄ = H | | | |
| 5 | Aromatic | Formula (1) | 2.0 | Na₂CO₃ (E) | 3.0 |
| | compound B | R₁ = H, R₂ = Me, R₃ = Et, R₄ = H | | Li₂CO₃ (F) | 0.8** |
| 6 | Aromatic | Formula (1) | 2.0 | Na₂CO₃ (E) | 3.0 |
| | compound B | R₁ = H, R₂ = Me, R₃ = Et, R₄ = H | | Li₂CO₃ (F) | 0.1** |
| Compar. | | | | | |
| Example | | | | | |

| 1 | Not added | | | Not added |
|---|---|---|---|---|
| 2 | Aromatic | Formula (2) | 2.0 | Not added |
| | compound C | R₁ = H, n = 4 | | |
| 3 | Aromatic | Formula (2) | 3.0 | Not added |
| | compound C | R₁ = H, n = 4 | | |

| | | | |
|---|---|---|---|
| 4 | Not added | Li₂CO₃ | 3.0 |
| 5 | Not added | Li₂CO₃ | 1.0 |

| | Evaluation | | | | | | |
|---|---|---|---|---|---|---|---|
| | of battery | | Test for overcharging | | | | |
| | | Battery | Current | | | | |
| | Battery | capacity | breaking | Voltage for | | | |
| | capacity | after storage | valve | current breaking | | | |
| | (mAh) | (mAh) | worked? | valve to work | Bursting | Ignition | Rating |
| Example | | | | | | | |
| 1 | 2010 | 1890 | yes | 4.6 | no | no | good |
| 2 | 2010 | 1900 | yes | 4.6 | no | no | good |
| 3 | 2010 | 1885 | yes | 4.6 | no | no | good |
| 4 | 2009 | 1891 | yes | 4.6 | no | no | good |
| 5 | 2008 | 1885 | yes | 4.6 | no | no | good |
| 6 | 2010 | 1890 | yes | 4.6 | no | no | good |
| Compar. | | | | | | | |
| Example | | | | | | | |
| 1 | 2010 | 1901 | no | — | yes | yes | poor |
| 2 | 2010 | 1900 | no | — | yes | yes | poor |
| 3 | 2001 | 1850 | no | — | yes | no | poor |
| 4 | 1995 | 1860 | yes | 5.0 | yes | no | poor |
| 5 | 2001 | 1865 | yes | 5.1 | yes | no | poor |

*Amount based on the positive electrode.
**In terms of F/(E + F).

### Explanation of Numerals

1 Positive electrode
2 Aromatic compound
3 Lithium-ion secondary battery
4 Current breaking valve

1. A lithium-ion secondary battery, comprising:
a positive electrode capable of occluding and releasing lithium ions;
a negative electrode capable of occluding and releasing lithium ions;
a separator interposed between the positive electrode and the negative electrode;
an electrolytic solution; and
a current breaking mechanism that works in response to the rise of the battery's internal pressure; wherein
the electrolytic solution is incorporated with an aromatic compound and the positive electrode is incorporated with a carbon dioxide gas generating agent which is represented by the formula AₓCO₃ or A_{y}HCO₃ (where A denotes an alkali metal with the atomic number 11 and above or an alkaline earth metal with the atomic number 4 and above, and x is 2 if A denotes an alkali metal and 1 if A denotes an alkaline earth metal and y is 1 if A denotes an alkali metal and 0.5 if A denotes an alkaline earth metal).

2. The lithium-ion secondary battery as defined in claim 1, wherein the aromatic compound generates protons at a potential no lower than 4.4 V and no higher than 4.8 V.

3. The lithium-ion secondary battery as defined in claim 2, wherein the aromatic compound is one represented by Formula 1 or Formula 2 or benzene, 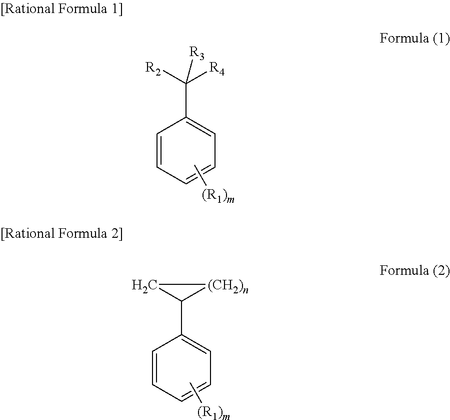
in Formula 1, R₁ denotes a hydrogen atom or hydrocarbon group, m is no larger than 5 if R₁ denotes a hydrocarbon group, and each of R₂, R₃, and R₄ denotes a hydrogen atom or hydrocarbon group, and
in Formula 2, which represents an aromatic compound having a substituent of alicyclic hydrocarbon, R₁ denotes a hydrogen atom or hydrocarbon group, m is no larger than 5 if R₁ denotes a hydrocarbon group, and n is no smaller than 1 and no larger than 14.

4. The lithium-ion secondary battery as defined in claim 3, wherein the electrolytic solution contains the aromatic compound in an amount no lower than 0.01 wt % and no higher than 10 wt % based on the amount of the electrolytic solution.

5. The lithium-ion secondary battery as defined in claim 4, wherein the carbon dioxide gas generating agent includes at least any one of sodium carbonate, potassium carbonate, magnesium carbonate, calcium carbonate, sodium hydrogen carbonate, potassium hydrogen carbonate, magnesium hydrogen carbonate, and calcium hydrogen carbonate.

6. The lithium-ion secondary battery as defined in claim 5, wherein said carbon dioxide gas generating agent contains lithium carbonate in an amount no smaller than 10 wt % and no larger than 80 wt %.

7. The lithium-ion secondary battery as defined in claims 1, wherein said carbon dioxide gas generating agent contains lithium carbonate in an amount no smaller than 10 wt % and no larger than 80 wt %.
